(19) United States
(12) Patent Application Publication
(10) Pub. No.: US 2026/0024342 A1
(43) Pub. Date: Jan. 22, 2026

(54) Sailboat Race Management System with Camera

(71) Applicant: WhitServe LLC, Stamford, CT (US)

(72) Inventors: Wesley W. Whitmyer, Jr., Stamford, CT (US); Declan W. Whitmyer, Stamford, CT (US)

(21) Appl. No.: 19/276,799

(22) Filed: Jul. 22, 2025

Related U.S. Application Data
(60) Provisional application No. 63/673,886, filed on Jul. 22, 2024.

(51) Int. Cl. G06V 20/52; G06V 10/70; G06V 20/40; H04N 23/695

(52) U.S. Cl. CPC G06V 20/52; G06V 10/70; G06V 20/40; H04N 23/695; G06V 2201/08

(57) ABSTRACT

A system for sailboat racing rule enforcement includes a camera for recording video of at least one racing sailboat; a mobile computing device for controlling the camera; a GPS antenna for resolving a current position of the camera; a processor for determining a desired position of the camera based on a GPS position selected from a group including a position of a mark of a race course, a position of a racing sailboat, a position of two racing sailboats, a position of reference marks on the sailboat, and combinations of these; an electric motor for moving the camera from the current position to the desired position to record a video of at least one racing sailboat; and software including Al for analyzing the video of the at least one racing sailboat for racing rule violations.

### TECHNICAL FIELD

The present application relates to systems for managing sailboat races. In particular, the present application relates to systems for managing sailboat races using a camera.

### BACKGROUND

Sailboat racing is largely a self-policing sport. When disputes arise over application of the racing rules of sailing, it is normally because one boat refuses to accept that it has violated a rule and punish itself. A panel of senior sailors normally hears presentations by both boats in a so-called protest hearing and then finds facts and issues a penalty if warranted. In higher level competitions, on-water umpires make instant penalty decisions.

As technology has advanced, video has been permitted in some protest hearings to aid in fact finding. More recently, it has been proposed, including in our own prior patent application U.S. Ser. No. 18/736,905, that performance data from each boat could be used to enhance protest hearing presentations and umpire decisions, including proposed penalties to augment the traditional methods of rules enforcement. Performance data can include things such as speed over ground, course over ground, heading, heel, trim, distance to the line, position and others. The performance data is directly sensed by instruments mounted to the sailboats, and incidents between boats can, but need not, be recreated in the form of an animation using time-synced performance data. Obviously, the quality and quantity of the performance data available will impact the quality of the rule-violation proposals made by such a system.

Many racing sailors participate in competitions that forbid sailors to use certain types of performance data. Often, the rules forbidding use of certain types of data are focused on smaller sailboats and so-called one-design sailboats. One-design sailboats are identically manufactured according to a set of Class Rules. In order to foster competition at reduced costs, Class Rules often prohibit the use of certain types of performance data and/or instruments in sanctioned, compliant competitions. Even in races where performance instruments are permitted, the quality/quantity of data available may not be the same for the boats involved in the protest such that the technology may not live up to its promise.

Examples of the type of performance data/instruments prohibited in some one-design class rules include: boat speed, wind speed, wind direction, distance to the line, electronic compasses. In other one-designs and on larger sailboats, there are no such restrictions but instrument systems relying primarily on GPS data to determine position or speed have limited accuracy. Some limitations are inherent to the available signal quality, and other limitations are financial. More expensive chips can produce higher quality data by simultaneously connecting to more satellites, but this is impractical on smaller boats for power and size reasons.

Another limitation on using both on-water umpires and performance data to improve sailboat racing rule enforcement is the development of sailing technologies. Even a decade ago, few sailboats operated at speeds above 10 knots. More modern boats frequently operate at over 30 knots, literally flying above the water surface by foiling which lifts the hull and reduces drag. Performance data sensed on sailboats moving at these speeds quickly becomes ever less reliable, especially with low to moderate cost instruments. And it becomes essentially impossible for umpires to follow sailboats at these speeds.

What is needed therefore is a system to enhance sailboat racing rule enforcement at low cost but with high reliability even at elevated sailboat speeds.

### SUMMARY

The invention provides a solution to these and other shortcomings of sailboat racing rules enforcement systems.

In one aspect the invention provides a sailboat racing rules enforcement system that uses a camera to visually capture to inspect two or more racing sailboats.

In another aspect the invention provides a sailboat racing rules enforcement system that uses video of two or more racing sailboats to determine rules violations.

In a further aspect the invention provides a sailboat racing rules enforcement system that uses a drone to capture video of two or more racing sailboats.

In yet another aspect the invention provides a sailboat racing rules enforcement instrument that uses Al to analyze video of two or more racing sailboats.

In yet a further aspect the invention provides a sailboat racing rules enforcement system in which a position of the racing sailboats and/or marks of the racecourse are used to position the camera but are not used as a factor in determination of rules violations.

In still another aspect the invention provides a sailboat racing rules enforcement system in which a position of one or more marks of the racecourse are used to position the camera.

### BRIEF DESCRIPTION OF THE DRAWINGS

FIG. 1 shows connections present in one embodiment of a system according to the present teachings.

FIG. 2 shows one embodiment of a system according to the present teachings.

FIG. 3 shows connections present in another embodiment of a system according to the present teachings.

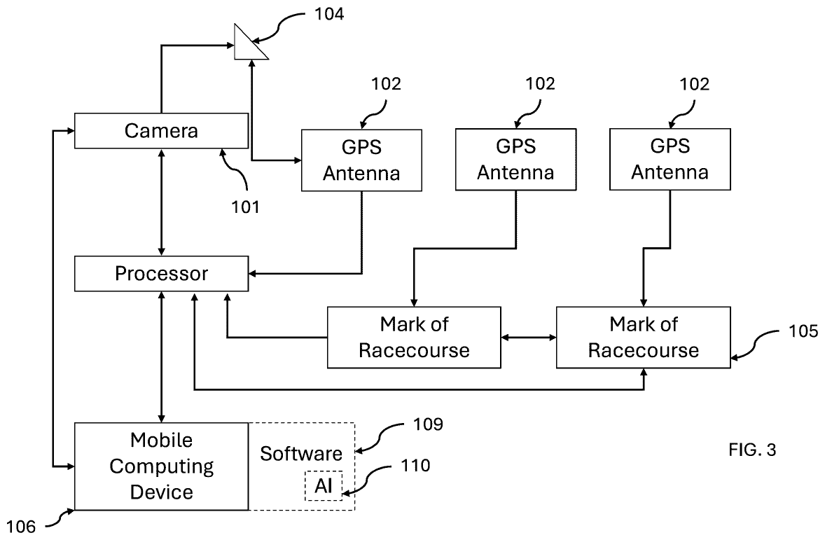

### DETAILED DESCRIPTION

The present teachings are described more fully hereinafter with reference to the accompanying drawings. The following description is presented for illustrative purposes only and the present teachings should not be limited to these embodiments.

In compliance with the statute, the present teachings have been described in language more or less specific as to structural features. It is to be understood, however, that the present teachings are not limited to the specific features shown and described, since the systems herein disclosed comprise preferred forms of putting the present teachings into effect.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first,” “second,” etc. for different features/components of the present disclosure are only intended to distinguish the features/components from other similar features/components and not to impart any order or hierarchy to the features/components.

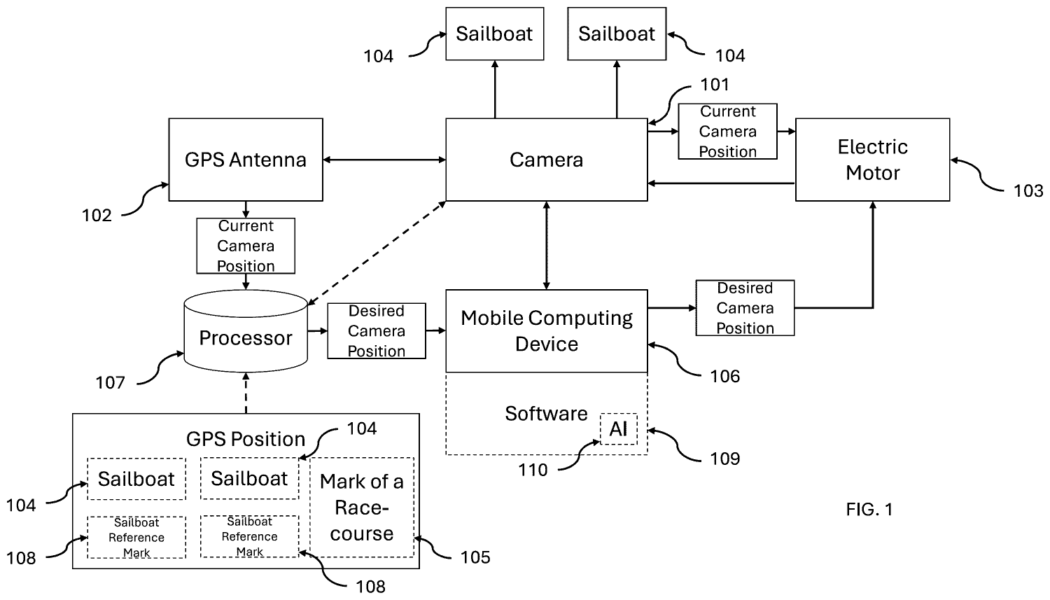

FIG. 1 shows connections present in one embodiment of a system according to the present teachings. It includes a camera 101, a GPS antenna 102, an electric motor 103, two sailboats 104 (and the GPS positions thereof), a racecourse mark 105, a mobile computing device 106, a processor 107, two sailboat reference marks 108, software 109, and artificial intelligence 110 (herein “AI”).

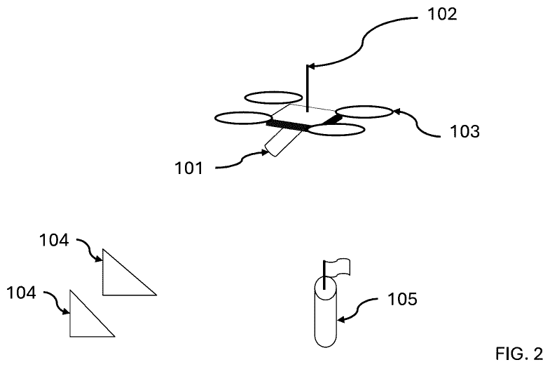

FIG. 2 presents one view of a system according to the present teachings. It includes a camera 101, a GPS antenna 102 for resolving the current position of the camera, an electric motor 103 for moving the camera, a sailboat 104, and a racecourse mark 105.

The camera 101 can be any type of camera known in the art. It is preferred that the camera 101 is suitable for operation in harsh environments, such as those commonly present while operating over the open ocean.

The present teachings may also include a mobile computing device 106. The mobile computing device 106 can be any suitable device in communication with the camera capable of controlling the camera 101. As understood herein, the term “controlling,” as used in the preceding sentence, may mean operating the movement of the one or more electric motors 103 or controlling features of the camera 101 or the position of the camera 101, including without limitation, the pan and tilt of the camera 101 or the zoom of a lens of the camera 101. In some embodiments, the mobile computing device 106 may include software 109 for analyzing video taken by the camera 101. In other embodiments, the software 109 for analyzing video taken by the camera 101 may be on another device. The software 109 may include Al 110 features for analyzing the video taken by the camera 101.

The mobile computing device 106 is preferably in electrical communication with the camera 101, of which electrical communication may be any suitable method. The mobile computing device 106 is envisioned in many physical forms. For example, the mobile computing device may be, without limitation, a smartphone, a tablet, or a handheld remote controller.

FIG. 2 shows a GPS antenna 102 mounted in close proximity to the camera 101, in particular, on a body connecting the plurality of electric motors 103, the camera 101, and the GPS antenna 102. However, in some embodiments, the GPS antenna 102 may be mounted on the camera 101. The GPS antenna 102 may be capable of transmitting location information to a processor (not shown) and/or to the mobile computing device 106.

In some embodiments of a system according to the present teachings, a plurality of GPS antennae 102 may be present. The plurality of GPS antennae 102 may be located in any suitable location for taking location data with respect to sailboat racing, including without limitation, mounted on a sailboat 104 or mounted on a racecourse mark 105. The plurality of GPS antennae 102 may be present in the form of a GPS chip on a smartphone or other computing device.

The present teachings may also include a processor 107, which may be mounted on the mobile computing device 106 or may be part of a separate computing device. The processor 107 may be in communication with the mobile computing device 106. The processor 107 may be in communication with one or more of the GPS antennae 102. The processor 107 is preferably capable of determining a desired position of the camera 101 after receiving data regarding the positioning of one or more features of the sailboat race, including without limitation, one or more sailboats 104 and/or one or more racecourse marks 105. The processor 107 may also be capable of communicating with the mobile computing device 106 for at least the purpose of moving the one or more electric motors 103.

An embodiment of the present teachings may be understood through example: multiple sailboats 104, each having a GPS antenna 102, are arranged near the starting line of a race, demarcated by a racecourse mark 105, each also having a GPS antenna 102. The positions of each of these boats 104, as well as the racecourse mark 105, are transmitted to a mobile computing device 106. A user operates the mobile computing device 106 and inputs a command that a race is about to start. A processor 107, also in communication with said mobile computing device 106, determines the proper location of the camera 101 based on the user's input to the mobile computing device 106. The processor 107 determines the proper location of the camera 101 by assessing the location of the sailboats 104 and the racecourse mark 105. The camera 101 is mounted to a body which is moveable by the electric motors 103. The processor 107, also in connection with the electric motors 103, sends commands to the electric motors 103 to move in such a way that the camera's field of view can fully capture the area between the racecourse mark 105. Once the electric motors 103 move the camera 101 into the correct position, the camera 101 begins recording. After the requisite amount of time has passed and the sailboats 104 have crossed the racecourse mark 105, the camera 101 stops recording. The camera 101 transmits the footage to the mobile computing device 106. The processor 107 then runs software 109 to analyze the footage taken by the camera 101 and make judgments about which the relative positions of the sailboats 104 with respect to the racecourse mark 105 while the race started. Using image processing software 109 ran solely on the footage taken from the camera 101, the processor 107 is capable of making an accurate judgement as to any rules violations, even at high speeds.

The example presented in the preceding paragraph is not meant to be understood as an exclusive use of the present teachings.

What is claimed is:

1. A sailboat racing rule enforcement system comprising:
a camera for recording video of at least one racing sailboat;
a mobile computing device for controlling said camera;
a GPS antenna for resolving a current position of said camera;
a processor for determining a desired position of said camera based on a GPS position selected from a group including a position of a mark of a race course, a position of a racing sailboat, a position of two racing sailboats, a position of reference marks on the sailboat, and combinations of these;
an electric motor for moving said camera from the current position to the desired position to record a video of at least one racing sailboat; and
software including Al for analyzing the video of the at least one racing sailboat for racing rule violations.

2. The sailboat racing rule enforcement system of claim 1, wherein the mobile computing device comprises a smartphone.

3. The sailboat racing rule enforcement system of claim 1, wherein there is a GPS antenna on at least one sailboat.

4. The sailboat racing rule enforcement system of claim 1, wherein there is a GPS antenna on at least one mark of a racecourse.
